(19) United States
(12) Patent Application Publication
(10) Pub. No.: US 2026/0326324 A1
(43) Pub. Date: Oct. 22, 2026

(54) RAZOR CARTRIDGE AND METHOD OF MANUFACTURE

(71) Applicant: Harry's, Inc., New York, NY (US)

(72) Inventors: Gregory J. DWYER, Wayne, NJ (US); Alexander CHENVAINU, Mahwah, NJ (US); Stefan SENS, Ridgewood, NY (US); Adam BENNANI, New York, NY (US)

(21) Appl. No.: 19/652,621

(22) Filed: Apr. 20, 2026

Related U.S. Application Data
(60) Provisional application No. 63/792,755, filed on Apr. 22, 2025.

(51) Int. Cl. B26B 21/22; B26B 21/52

(52) U.S. Cl. CPC B26B 21/225; B26B 21/521

(57) ABSTRACT

A razor cartridge comprising a blade unit pivotally mounted on a handle connection portion, the blade unit having receiver openings on a back surface for receiving opposed feet on the handle connection portion, the handle connection portion comprising a handle connector configured to be releasably attached to a handle and a yoke comprising two arms with opposed feet extending from terminal ends of the arms that engage the receiver openings on the blade unit. The cartridge is manufactured by angling the yoke as it advances toward the blade unit, inserting one foot on one arm of the yoke into one receiver opening while the other foot on the other arm of the yoke is not yet at the blade unit, deflecting the arms, by a value slightly greater than the length of the second foot, pivoting the yoke so that the second foot aligns with the second receiver opening on the blade unit; and releasing the arms of the yoke so that the second foot enters and rests in the second receiver opening of the blade unit.

### FIELD OF THE INVENTION

The present invention relates to disposable wet shave razor cartridges designed for replaceable attachment to a razor handle and methods of manufacturing the same.

### BACKGROUND OF THE INVENTION

Wet shave razors having replaceable blade cartridges are well known in the art. One example of such a razor is described in U.S. Pat. No. 5,787,586, where the blade cartridge comprises a blade unit and a handle connection portion, the blade unit being pivotally connected to the handle connection portion. In this embodiment, the handle connection portion includes a Y-shaped yoke, with arms extending upwardly and outwardly from a handle connector, the arms terminating in an outwardly extending foot on each arm. The feet fit into opposed receiver openings on the back of the blade unit to hold the blade unit on the handle connection portion, while allowing the blade unit to pivot on the arms.

During manufacture of the razor cartridge, and particularly when attaching the handle connection portion to the blade unit, the arms are squeezed together, so that the ends of the feet can simultaneously fit between the opening edges of the opposed openings. The arms are then released, so the feet are captured in the receiver openings. However, this process has been found to have drawbacks, particularly where sufficiently squeezing the arms so that the ends of the feet can fit between the opening edges of the receiver openings can create stress and potential failure in the material of the arms.

To address this issue, manufacturers have tried several modifications to the razor cartridge. For example, manufacturers have tried using more flexible materials for the arms of the handle connection portion or longer arms that flex more easily. However, using more flexible materials or longer arms can result in the blade unit being unintentionally dislodged from the handle connection portion, releasing the opposed feet from the opposed receiver openings when the arms unintentionally bend during a razor drop event.

Another option has been to use a larger space between the openings and/or a smaller space between the arms, so the arms do not need to be squeezed as much to get the ends of the feet between the opposed receiver openings on the blade unit. However, enlarging the space between the receiver openings and/or reducing the space between the arms can result in additional unwanted movement between the arms of the handle connection portion and the space between the openings, sacrificing a precise, close tolerance connection between the parts. This option can also allow the arms to unintentionally release from the blade unit during a razor drop event.

Other modifications considered include reducing the length of the feet extending into the receiver openings, so the arms do not need to be squeezed so close together for the ends of the feet to clear the space between opening edges of the opposed receiver openings during insertion. However, reducing the length of the feet also sacrifices retention of the blade unit on the handle connection portion, similarly increasing the potential for the blade unit to be unintentionally dislodged from the handle connection portion when the razor is dropped.

Accordingly, there is a need for an improved razor cartridge, one that minimizes the gap between arms at the feet in relationship to the distance between the openings on the blade unit, maximizes the length of the feet received into the openings on the blade unit for better retention on the handle connection portion, and allows more resilient materials to be used for the Y-shaped yoke of the handle connection portion.

### SUMMARY OF THE INVENTION

The present invention is directed to a razor cartridge and method of manufacture, where the razor cartridge comprises a blade unit mounted on a handle connection portion, the blade unit preferably being pivotally mounted on the handle connection portion. The handle connection portion comprises a handle connector, preferably including components that work with cooperating components on a handle to releasably connect the razor cartridge to the handle, and a blade unit connector. The blade unit connector preferably comprises a yoke featuring two arms with opposed feet, the opposed feet either extending outwardly in opposite directions from the terminal ends of the arms or, alternatively, extending inwardly toward each other from the terminal ends of the arms. The blade unit comprises the shaving blades on a front surface and opposed receiver openings on the back surface for receiving the opposed feet of the yoke, for pivotally retaining the blade unit on the handle connection portion.

It has been found that increasing the length of each foot, so that each foot extends a greater distance into the respective opposed receiver opening for a greater overlapping dimension, results in an improvement in keeping the blade unit attached to the handle connection portion, particularly on the occasion of when the razor is dropped. Accordingly, the present cartridge maximizes the length of the feet on the yoke of the handle connection portion of the cartridge. In one embodiment, the length of each foot, measured from an outer edge of the corresponding arm of the yoke, is from about 1.78 mm to about 2.22 mm, with about 2.00 mm being most preferred.

It has also been found that minimizing the gap between the outer edges of the arms below the feet and the opening edges of the opposed receiver openings into which the feet are inserted limits lateral movement of the blade unit on the handle connection portion. In one embodiment, when the blade unit is pushed to one side of the yoke, so there is no gap on one side with the entire gap on the other side, the gap between the outer edge of the arms of the yoke and the opening edges of the receiver openings is from about 0.28 mm to about 0.77 mm, and preferably from about 0.50 mm to about 0.55 mm. Of course, if the blade unit is centered on the yoke, the values above would be approximately one-half of the above on each side.

This is also measurable in the overlap distance, i.e., the distance from the edge of the receiver opening to the terminal end of the foot within the receiver opening. In one embodiment of the present invention, when the blade unit is pushed to one side of the yoke with no gap, the overlap distance of the foot on the side with the gap is from about 1.28 mm to about 1.72 mm, with about 1.50 mm being most preferred. The described overlap distance has been found to provide improved resistance to disengagement during a drop event, where such an event starts with no gap on the drop side and the arm on the drop side deflects to reduce the overlap distance through the drop event. In such a case, the overlap distance defines a worst case scenario drop event, i.e., the distance the arm can deflect before the foot exits the receiver opening and the blade unit is released from the handle connection portion.

Additionally, it has been found that the length of the arms of the yoke can be reduced, for further improving the connection with the blade unit, where a reduced deflection of the arms is required to position the feet for insertion into the respective receiver openings. In this regard, although shorter arms may be more difficult to deflect when squeezed, the difficulty is offset by one foot being inserted into one receiver opening prior to moving the second foot into alignment with the second receiver opening for insertion.

The reduced arm length also provides improved retention of the blade unit on the yoke of the handle connection portion, where the shorter arm is less likely to deflect to the point where one foot is released from its corresponding receiver opening. The shorter arm also serves to improve control of the razor during shaving. In one embodiment, the length of the arm from the handle connector to the top of the foot is from about 8.92 mm to about 9.28 mm, with about 9.10 mm being most preferred.

The invention contemplates, without being bound by theory, a defined relationship that ties the significant factors together to maximize blade unit retention on the yoke of the handle connection portion. The factors considered to be most significant to the present invention include:
Arm stiffness, which depends on Arm length, L;
Arm thickness, T (in the direction of bending);
Arm base dimension, B (less of a factor); and
Material properties (modulus, E).

The relationship between the Force (F) required to deflect and the arm properties can be defined by the following formula: Deflection required=(F*L\hat{ }3)/(3EI), where I=area moment of inertia I=(B*T\hat{ }3)/12.

The amount of deflection needed before foot can release from the receiver openings is generally governed by:
Side to side width across both arms, adjacent to the feet (AW=arm width)
Width between receiving openings for feet (RW=receiving width)
Foot length (FL=foot length)

These three factors determine the amount of foot overlap in receiving portion, i.e.: Deflection required=AW+FL−RW.

The remaining unknown is load F, as well as a slight geometric factor due to the angle of the arms, which depends on the drop orientation.

To provide an improved razor cartridge in keeping with the present invention, an improved method of manufacturing a razor cartridge has been found, particularly with respect to attaching the yoke of the handle connection portion to the blade unit. This improved method allows for the length of each foot on the yoke arms to be maximized and the gap between the edges of the yoke arms and the edges of the blade unit receiver openings to be minimized, among other things.

The method of manufacturing a razor cartridge according to the present invention comprises providing a handle connection portion with a handle connector and a Y-shaped yoke comprising two arms each terminating in an opposed outwardly extending foot, each foot having a terminal end; providing a blade unit with opposed receiver openings on a back surface, the opposed openings configured to receive the outwardly extending feet, where there is a separation distance between edges of the opposed receiver openings; angling the yoke as it advances toward the blade unit for engagement, so that a first foot on one arm is in a leading position relative to the blade unit; inserting the first foot on one arm of the yoke into a first receiver opening while the second foot on the other arm of the yoke is not yet at the blade unit; deflecting the arms of the yoke toward each other, to reduce the width between the terminal ends of the feet by a value corresponding to the length of the second foot, so the second foot can move past the opening edge of the second retainer opening and into alignment with the second receiver opening; rotating the handle connection portion so that the second foot aligns with the second receiver opening on the blade unit; releasing the force deflecting the arms of the yoke so that the second foot enters and rests in the second receiver opening of the blade unit.

Of course, the above described method is also applicable to the embodiment where the feet at the ends of the arms extend inwardly toward each other rather than away from each other. This embodiment comprises providing a handle connection portion with a handle connector and a Y-shaped yoke comprising two arms each terminating in an inwardly extending foot, each foot having a terminal end; providing a blade unit with opposite outwardly facing receiver openings on a back surface, the opposite openings configured to receive the inwardly extending feet, where there is a separation distance between edges of the opposite receiver openings; angling the yoke as it advances toward the blade unit for engagement, so that a first foot on one arm is in a leading position relative to the blade unit; inserting the first foot on one arm of the yoke into a first receiver opening while the second foot on the other arm of the yoke is not yet at the blade unit; deflecting the arms of the yoke away from each other, to increase the width between the terminal ends of the feet by a value corresponding to the length of the second foot, so the second foot can move past the opening edge of the second retainer opening and into alignment with the second receiver opening; rotating the handle connection portion so that the second foot aligns with the second receiver opening on the blade unit; releasing the force deflecting the arms of the yoke so that the second foot enters and rests in the second receiver opening of the blade unit.

In one embodiment, the angle of the handle connection portion as it approaches the plane of the opposed receiver openings, taken across the plane of the opposed feet, is preferably from about 15 degrees to about 45 degrees, with about 45 degrees being most preferred. In a preferred embodiment, the second foot on the second arm of the yoke is rotated or pivoted into alignment with the second receiver opening as the yoke arms are being deflected. In another embodiment, however, the yoke arms can be deflected prior to rotating or pivoting the second foot on the second yoke arm into alignment with the second receiver opening.

It is preferred that the yoke arms, measured from the terminal end of one foot to the terminal end of the other foot, are deflected by a distance only slightly more than the length of the second foot to clear the opening edge of the second receiver opening during assembly of the cartridge. This minimizes the stress on the material of the arms and maximizes the preferred specifications for the component parts. In one embodiment, the distance from the side of the first arm with the first foot inserted into the first receiver opening to the terminal end of the second foot when the yoke arms are deflected to align the second foot with the second receiver opening is a value that is from about 26.88 mm to about 27.52 mm, with about 27.20 mm being most preferred.

Of course, the opposed feet do not need to be the same length, where it is contemplated that the first foot being inserted into the first receiver opening can be slightly longer than the second foot being inserted into the second receiver opening.

Facilitating the assembly of the blade unit and handle connection portion is the use of machine parts in the assembly of the razor cartridge component, preferably including a retainer, which captures the blade unit for attachment of the yoke, a guided feed on which the handle connection portion advances toward the blade unit and a split pusher. The split pusher has one side starting at a shorter distance than the other, for advancing the handle connection portion toward the blade unit at an angle until insertion of the first foot into the first receiver opening and rotating or pivoting the handle connection portion for alignment of the second foot with the second receiver opening.

The retainer is used to hold the blade unit in place during the insertion of the first foot, pivoting of the handle connection portion, squeezing of the yoke arms and insertion of the second foot into the second receiver opening. In one embodiment, the inner walls of the receiver converge as they approach the end on which the blade unit resides, to deflect the arms of the yoke until the second foot can fit within the opening edge of the second receiver opening on the blade unit. In another embodiment, an internal spreader deflects the arms of the yoke until the second foot can clear the opening edge of the second receiver opening on the blade unit. In either embodiment, the second foot clears the opening edge of the second receiver opening so the second foot can be dropped into the second receiver opening.

The split pusher advances the handle connection portion at an angle to the blade unit, where one side of the pusher extends farther than the other side, to contact one side of the handle connection portion associated with a first arm of the yoke, while the other side of the pusher is trailing the first side, to contact the other side of the handle connection portion associated with the second arm of the yoke. The split pusher is preferably configured to linearly extend the second side of the pusher, once the first foot is inserted into the first receiver opening, to rotate the handle connection portion as the second pusher advances until the second foot is in alignment with the second receiver opening. The split pusher then retracts, once the second foot advances beyond the rail and is inserted into the second receiver opening.

Accordingly, the split pusher can have two independently advancing sides, where the first side starts at a leading position and the second side advances once the first side reaches the end of its travel. Alternatively, the pusher can be configured to pivot, with one side longer than the other, using for example a rocker, a cam, or other rotating feature with a non-uniform radius that contacts the first and second sides such that the handle connection portion is angled as it advances. Once the first foot is inserted into the first receiver opening, advancing the second foot into alignment with the second receiver opening is accomplished by the rotation of the rocker, cam, or other rotating feature. In either case, the pusher retracts once both sides have advanced to insert the second foot into the second receiver opening, and resets its angular orientation.

Because the distance between the terminal ends of the arms is deflected a distance that corresponds to the length of the second foot, it eliminates the need for any region of reduced dimension on the blade unit leading up to the opposed receiver openings. This allows the feet to more easily snap into place without sacrificing the integrity of the feet or the edges of the receiver openings on the blade unit.

Once the second foot has been received in the second receiver opening, the assembly of the handle connection portion on the blade unit is complete and the razor cartridge can be removed from the retainer.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a rear view of the razor cartridge of the present invention.

FIG. 2 is a partly exploded rear view of the razor cartridge of FIG. 1.

FIG. 3 is a partial perspective view of the back of the blade unit housing of the razor cartridge of FIG. 1.

FIG. 4 is a plan view of the assembly method with the parts stacked and the blade unit fitted on a retainer, prior to engagement of the split pusher.

FIG. 5 is a plan view of the assembly method with the parts stacked, as the split pusher begins to engage the handle connection portion.

FIG. 6 is a plan view of the assembly method with the parts stacked, as the split pusher advances one arm into the retainer holding the blade unit.

FIG. 7 is a plan view of the assembly method with the parts stacked, as the split pusher further advances one arm into the retainer holding the blade unit.

FIG. 8 is a plan view of the assembly method with the parts stacked, as the split pusher advances one arm further into the retainer holding the blade unit and the first foot is moving toward the first receiver opening.

FIG. 9 is a plan view of the assembly method with the parts stacked, as the split pusher advances one arm further into the retainer holding the blade unit and the first foot is about to enter the first receiver opening.

FIG. 10 is a plan view of the assembly method with the parts stacked and the first foot positioned in the first receiver opening. The linearly extending second side of the split pusher has advanced by sliding toward the direction of the retainer. This motion of the second side of the split pusher results in the second arm moving closer toward the second receiver opening, and the arms have been squeezed together by converging inner walls of the retainer as a result.

FIG. 11 is a plan view of the assembly method with the first foot in the first receiver opening and the second foot in the second receiver opening, the split pusher being disengaged and pulled back from the assembly.

FIG. 12 is a plan view of the assembled cartridge being removed from the retainer.

FIG. 13 is a plan view of the assembled cartridge having been removed from the retainer.

FIG. 14 is a bottom view of the handle connection portion as placed in the retainer holding the blade unit.

FIG. 15 is a plan view of the handle connection portion with the first foot entering the first receiver opening of the blade unit mounted on the retainer.

FIG. 16 is a plan view of the handle connection portion as it advances toward the blade unit, illustrating an angle of advance.

FIG. 17 is an exploded rear view of the razor cartridge with the alternative embodiment of the feet on the arms extending in an inward direction and the opposite receiver openings facing in opposite directions.

### DETAILED DESCRIPTION OF THE PREFERRED EMBODIMENTS

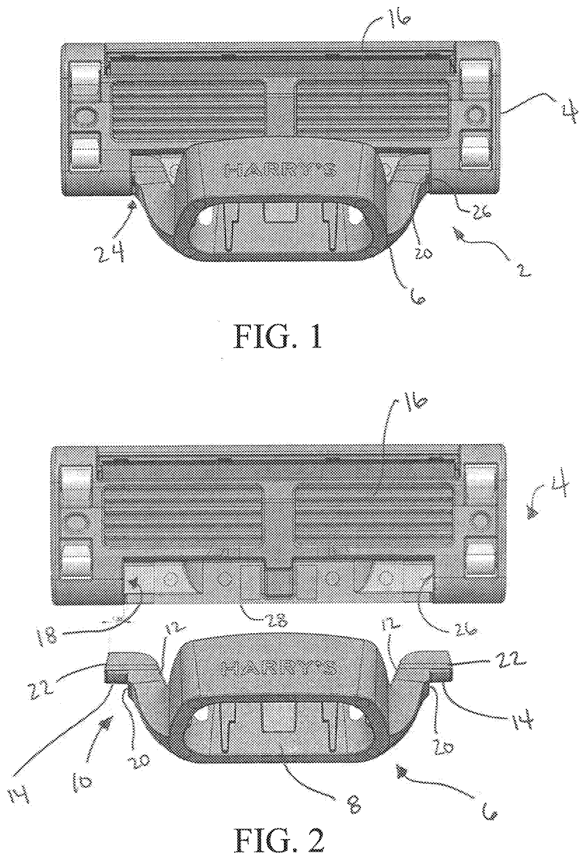

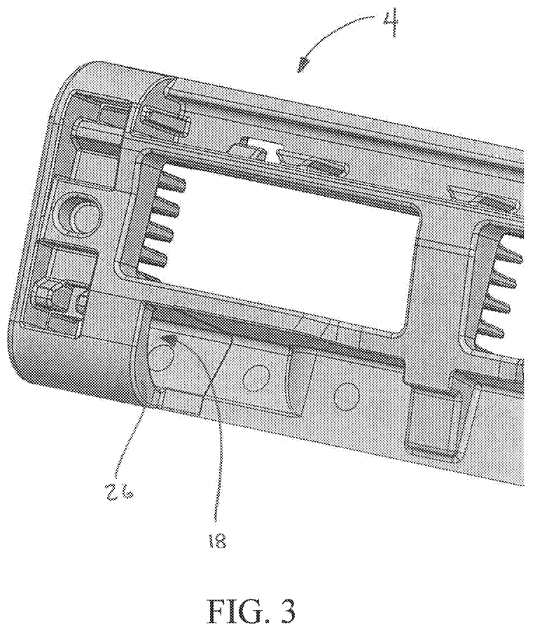

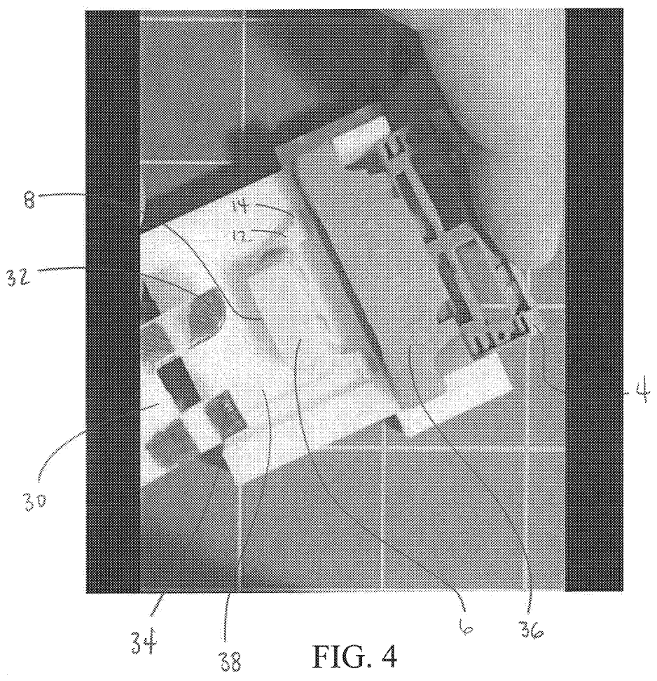

The preferred disposable razor cartridge 2 of the present invention, as shown in FIGS. 1-3, comprises a blade unit 4 and a handle connection portion 6 pivotally attached to the blade unit 4.

The handle connection portion 6 comprises a handle connector 8, preferably including components that work with cooperating components on a handle (not shown) to releasably fix the razor cartridge 2 on the handle, and a blade unit connector, preferably comprising a yoke 10 featuring a pair of arms 12 with opposed feet 14 extending outwardly in opposite directions from the terminal ends of the arms 12. The blade unit 4 comprises the shaving blades 16 on a front surface, seen from the rear surface through openings in the middle of the blade unit, and opposed receiver openings 18 on the back surface for receiving the opposed feet 14 of the yoke. Insertion of the feet 14 of the yoke 10 into the receiver openings 18 provide a secure pivoting connection between the blade unit 4 and the handle connection portion 6.

The feet 14 at the ends of the arms 12 forming the yoke 10 of the handle connection portion 6 extend a greater distance from the arms 12, allowing the feet 14 to extend a greater distance into the respective receiver openings 18 on the blade unit 4. Other factors being equal, the greater the extension of the feet 14 into the respective receiver openings 18, the more securely the blade unit 4 will be attached to the handle connection portion 6. This improved connection between the blade unit 4 and the handle connection portion 6 provides an improved potential for the handle connection portion 6 to remain connected to blade unit 4 even if the razor is dropped.

According to the present invention, the length of the feet 14 on the yoke 10 of the handle connection portion 6, measured from an edge 20 of the corresponding arm 12 of the yoke 10 to the terminal end 22 of the foot, is from about 1.78 mm to about 2.22 mm, with about 2.00 mm being most preferred. This increased foot length improves the connection of the handle connection portion 6 to the blade unit 4.

The present razor cartridge 2 also seeks to minimize the gap 24 between the edge 20 of the arm 12 and an opening edge 26 of the corresponding receiver opening 26. Minimizing the gap 24 results in less lateral movement of the blade unit 4 on the handle connection portion 6. Of course, reducing the gap 24 reduces the lateral movement of the blade unit 4 on the handle connection portion 6, ultimately improving control of the razor during shaving.

In the preferred embodiment shown, the gap 24 between the edge 20 of the arms 12 of the yoke 10 and the opening edges 26 of the receiver openings 18, when the blade unit 4 is pushed to one side so that the gap is only on the other side, is reduced to from about 0.28 to about 0.77 mm, and preferably from about 0.50 to about 0.55 mm. This gap 24 between the edges of the arms 12 and the opening edges 26 of the receiver openings 18 limits lateral movement of the blade unit 4 on the handle connection portion 6 while providing sufficient clearance for the blade unit 4 to pivot on the handle connection portion 6.

Further in keeping with the benefits of the preferred razor cartridge 2 and method of assembly, described in further detail below, the length of the arms 12 themselves can be reduced, improve retention of the blade unit 4 on the handle connection portion 6. This is because the present invention requires less deflection of the arms 12 to position the feet 14 into the receiver openings 18. Shorter arms 12 also improve control of the razor during shaving, since the user can grasp the razor closer to the blade unit 4, to more precisely direct the motion of the blades 6 when shaving.

Accordingly, the length of the arm 12, measured from the top of the handle connector 8 to the terminal end of the arm 12 from which the foot 14 extends, is from about 8.92 mm to about 9.28 mm, with about 9.10 mm being most preferred.

The improved performance of the razor cartridge 2 described here is achieved by an improved method of assembling the razor cartridge 2, including the method of attaching the yoke 10 of the handle connection portion 6 to the blade unit 4. Using the method of assembly described below allows for the length of the feet 14 on the arms 12 to be maximized and the gap 24 between the edges 20 of the yoke arms 12 and the opening edges 26 of the receiver openings 18 on the blade unit 4 to be minimized, as well as affording other benefits to the razor cartridge 2.

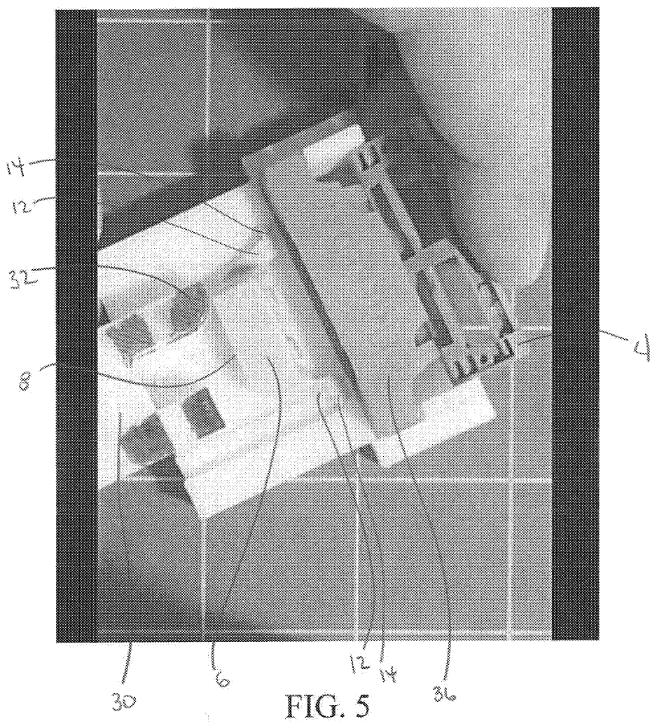

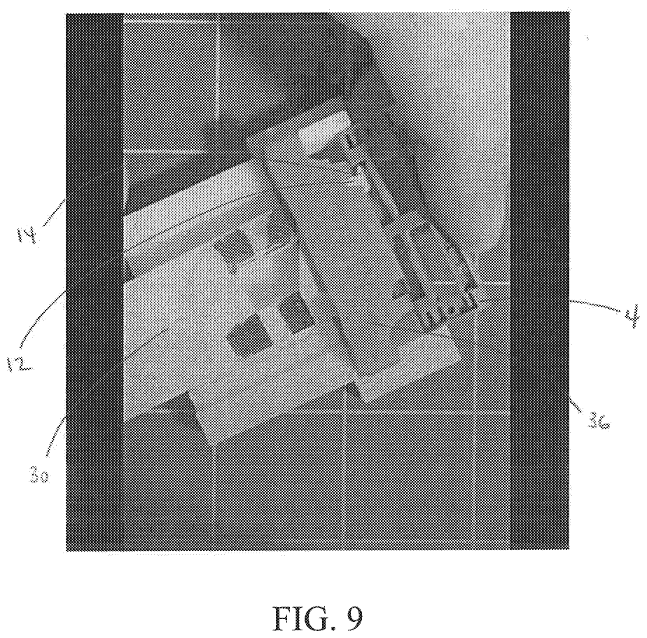

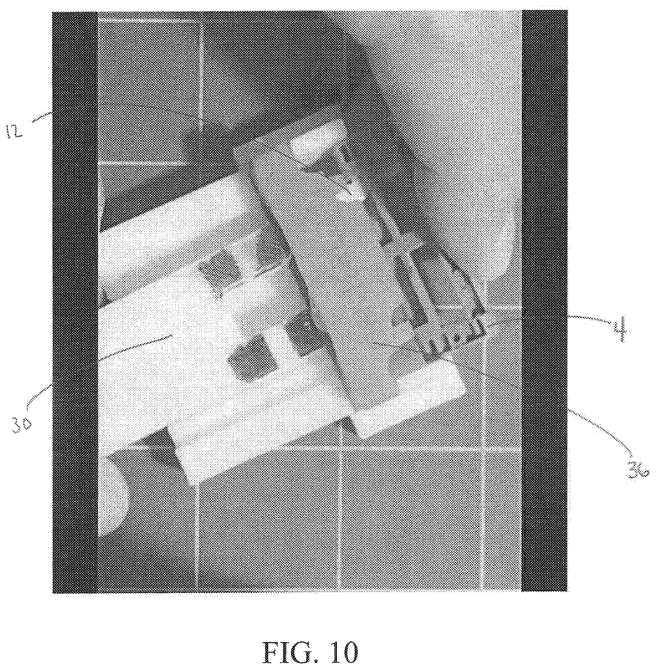

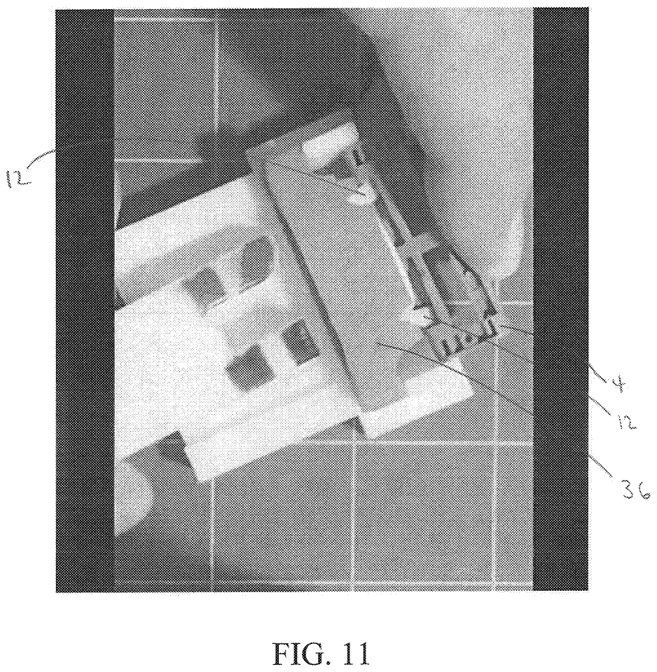

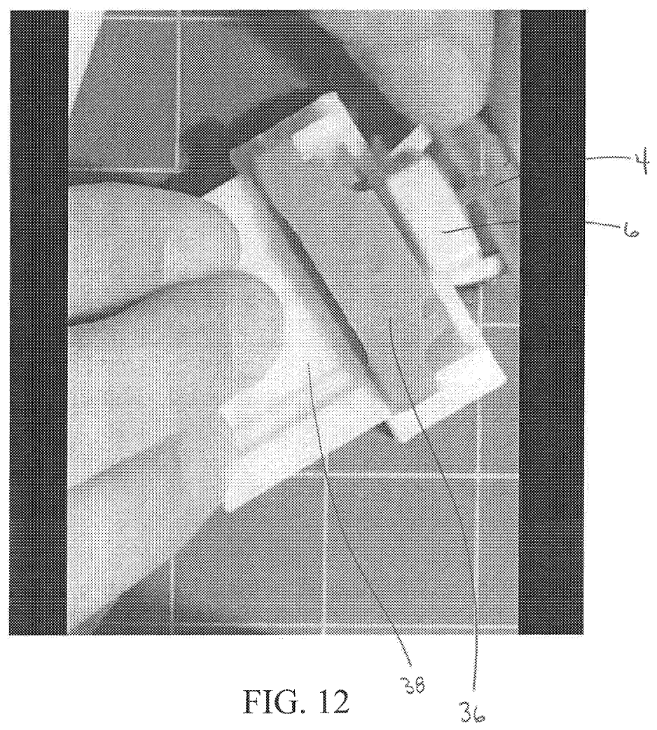

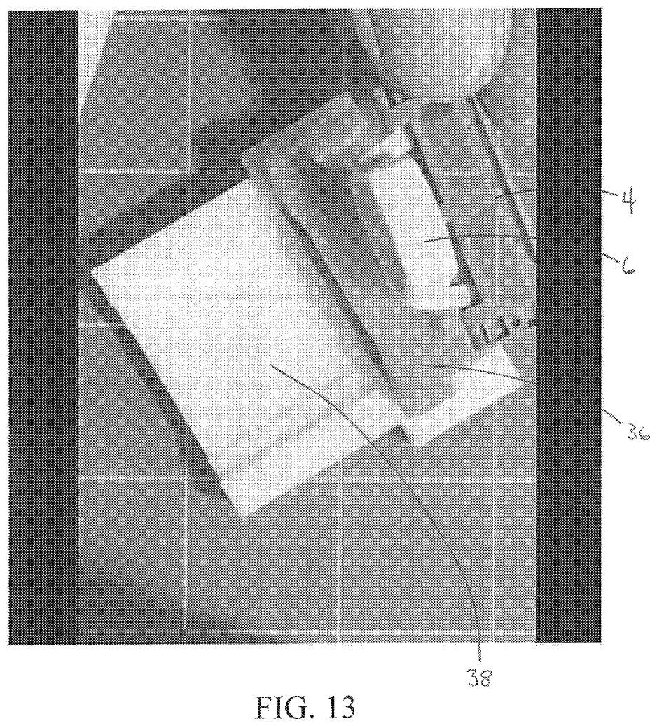

FIGS. 4-13 illustrate a preferred sequence of the method of assembly of the razor cartridge 2 of the present invention, without prejudice. In its broadest concept, the method comprises providing a handle connection portion 6 with a handle connector 8 and a Y-shaped yoke 10 comprising two arms 12, each terminating in an opposed outwardly extending foot 14 having a terminal end 22. A blade unit 4 with opposed receiver openings 18 on a back surface, the opposed openings 18 configured to receive the outwardly extending feet 14, is also provided where there is a separation distance between opening edges 26 of the opposed receiver openings 18.

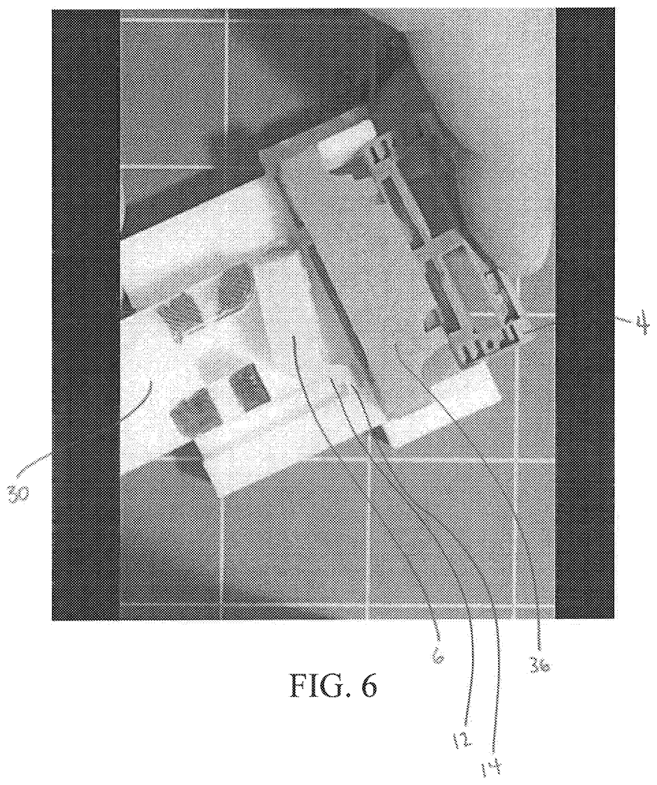

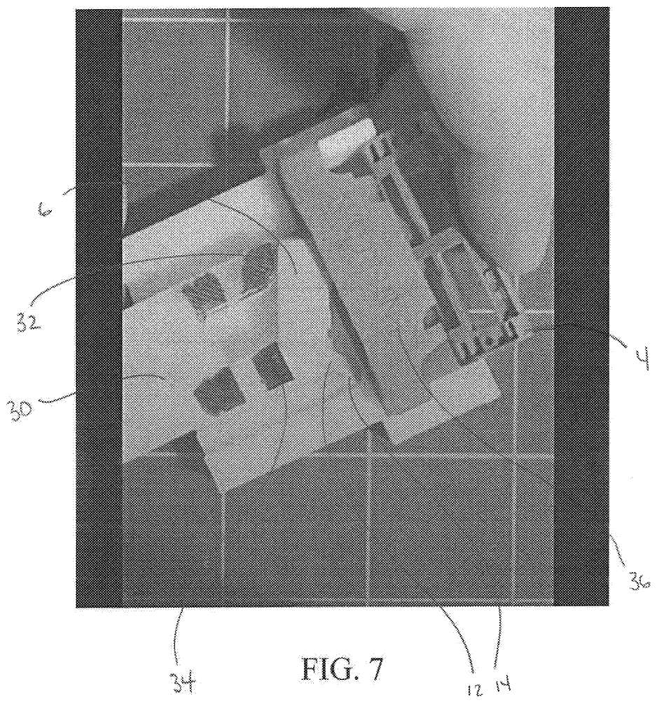

In a preferred method of assembly, a retainer 36 is used to capture and hold the blade unit 4 during attachment of the blade connection portion 6. A railed feed 38 is provided on which the handle connection portion 6 advances toward the blade unit 4. A split pusher 30, having a first side 32 which begins in a leading position to a second side 34, begins pushing against the handle connector 8 to advance the handle connection portion 6 toward the blade unit 4. See FIGS. 6-7.

The split pusher 30 thereby provides that the yoke 10, forming part of the handle connection portion 6, is angled with respect to the leading edge 28 of the blade unit 4 while the handle connection portion 6 advances toward the blade unit 4 for engagement. Accordingly, a first foot 14 on a first arm 12 is in a leading position to a second foot 14 on a second arm 12 relative to the blade unit 2.

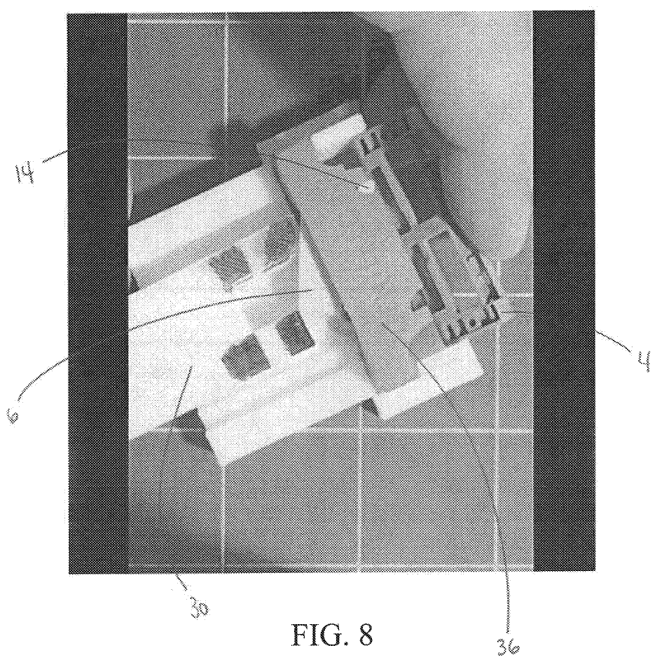

As the handle connection portion 6 advances at an angle toward the blade unit 4, the first foot 14 on the first arm 12 of the yoke 10 is inserted into a first receiver opening 18 (see FIGS. 8-10), while the second foot 14 on the second arm 12 of the yoke 10 is not yet at the blade unit 4.

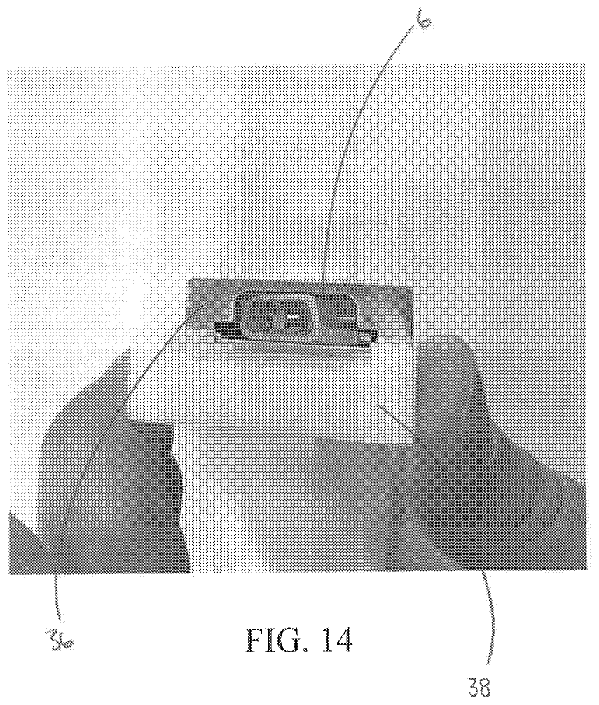

When the first foot 14 is inserted into the first receiver opening 18 and the handle connection portion 6 continues to advance into the retainer 36, the handle connection portion 6 and yoke 10 pivot within the retainer 36. Internal to the retainer 36, an inner wall associated with the second foot 14 (not shown) converges inwardly to press against the second foot 14 as it advances in the retainer 36, deflecting the arms 12 of the yoke 10. The largest opening of the retainer 36 is sized to hold the handle connector 8 of the handle connection portion 6 securely, to prohibit torsional movement within the handle connection portion 6 when the arms 12 are deflected. See FIG. 14.

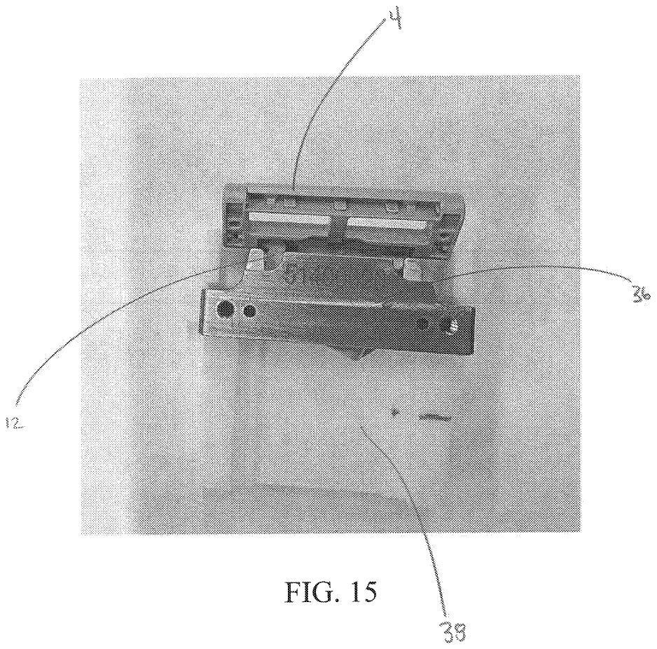

The convergence of the inner wall of the retainer 36 associated with the second foot 14 toward the opposed inner wall reduces the width from the edge 20 of the first arm to the terminal end 22 of the second foot 14 by about the length of the second foot 14, so that the second foot can move past the opening edge 26 of the second retainer opening 18 and into alignment with the second receiver opening 18, while pivoting the handle connection portion 6, until that the second foot 14 on the second arm 12 of the yoke 10 aligns with the second receiver opening 18 on the blade unit 4. Once aligned, the inner wall of the retainer 36 associated with the second foot 14 terminates, as shown in FIG. 15, releasing the compression force on the arms 12 of the yoke 19 so that the second foot 14 enters and rests in the second receiver opening 18 of the blade unit 4.

When defining the value of deflection as corresponding to or about the length of the second foot 14, it is understood that the deflection takes into account the need to clear the opening edge 26 of the second receiver opening 18 as well as the value of the gap 24 when the blade unit 4 is fixed on the handle connection portion 6. Therefore, the amount of deflection will have a value that is slightly more or less than the length of the second foot 14.

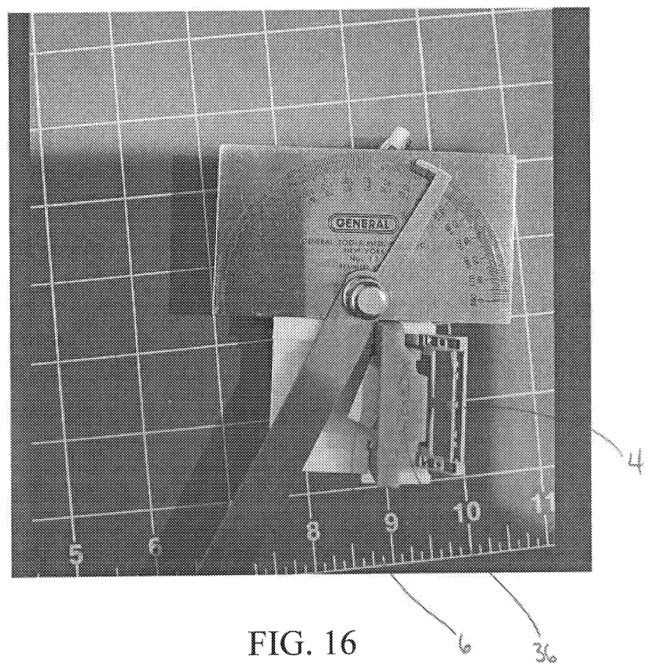

The angle of the handle connection portion 6 as it approaches the plane of the leading edge 28 of the blade unit 4 and the opposed receiver openings 18, taken across the plane of the opposed feet 14, is preferably from about 15 degrees to about 45 degrees, with about 30 degrees being most preferred. See FIG. 16. This angle provides that the first foot 14 is inserted into the first receiver opening 18 just as yoke 10 begins pivoting toward the blade unit 4.

In the preferred embodiment shown, the yoke arms 12, measured from the terminal end 22 of one foot 14 to the terminal end 22 of the opposed foot 14, are deflected by an amount corresponding to the length of the second foot 14, allowing the second foot 14 to clear the edge 26 of the second receiver opening 18 during assembly of the razor cartridge 2. It is preferred that the distance from the edge 20 of the first arm 12 to the terminal end 22 of the second foot 14, when the yoke arms 12 are deflected to align the second foot 14 with the second receiver opening 18, is reduced by a distance that is from about 1.25 mm to about 1.75 mm, with about 1.50 mm being most preferred, slightly less to slightly greater than the length of the second foot 14 being inserted into the corresponding second receiver opening 18, in view of the absence of a gap when the first foot 14 is fully inserted into the first receiver opening while the arms are deflected. This amount is minimized, provided solely to provide clearance of the foot 14 past the opening edge 26 of the receiver opening 18 during assembly.

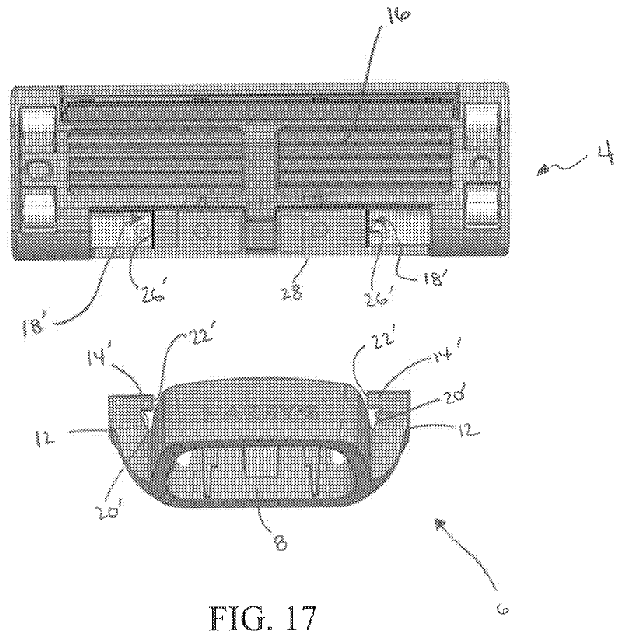

As shown in FIG. 17, the present invention can be practiced where the feet 14′ on the arms 12′ extend inwardly, toward each other, rather than outwardly. As will be appreciated by one skilled in the art, the same properties apply, however, the inward extending feet 14′ extend a distance from the edges 20′ of the arms 12′ to terminal ends 22′. The arms 12′ are deflected outwardly during assembly, so that the second foot 14′ clears the opening edges 26′ of the second receiver opening 18′.

While certain exemplary embodiments have been described and shown in the accompanying drawings, it is to be understood that such embodiments are merely illustrative and not restrictive of the current invention, and that this invention is not restricted to the specific constructions and arrangements shown and described, since variation, modification, and/or alternatives can be recognized to those ordinarily skilled in the art. All such variations, modifications and/or alternatives are intended to fall within the scope of the present invention, limited only by the appended claims.

The term “comprising” as used in the following claims is an open-ended transitional term that is intended to include additional elements not specifically recited in the claims. It is also noted that any feature or element positively identified in this document may also be specifically excluded as a feature or element of an embodiment of the present invention. Any and all patents and/or patent applications referred to herein are hereby incorporated by reference.

1. A method of manufacturing a razor cartridge comprising:
a. providing a handle connection portion with a handle connector and a Y-shaped yoke comprising a first arm and a second arm, each arm terminating in an opposed outwardly extending foot, each foot having a length and a terminal end;
b. providing a blade unit with opposed receiver openings on a back surface, the opposed openings configured to receive the outwardly extending feet, where there is a separation distance between edges of the opposed receiver openings;
c. angling the yoke as it advances toward the blade unit for engagement, so that a first foot on the first arm is in a leading position relative to the blade unit;
d. inserting the first foot on the first arm of the yoke into a first receiver opening while a second foot on the second arm of the yoke is not yet at the blade unit;
e. deflecting the first and second arms of the yoke toward each other, to reduce the width between the terminal ends of the feet by a value corresponding to the length of the second foot, so the second foot can move past the opening edge of the second retainer opening and into alignment with the second receiver opening;
f. rotating the handle connection portion so that the second foot aligns with the second receiver opening on the blade unit;
g. releasing the force deflecting the arms of the yoke so that the second foot enters and rests in the second receiver opening of the blade unit.

2. The method of claim 1 wherein the length of the first foot is equal to or greater than the length of the second foot.

3. The method of claim 1 wherein the angle of the yoke as the first foot is at the first receiver opening is from about 15 degrees to about 45 degrees.

4. The method of claim 1 wherein the angle of the yoke as the first foot is at the first receiver opening is about 30 degrees.

5. The method of claim 1 wherein the blade unit is fixed by a retainer and the handle connection portion is advanced toward the blade unit on a railed feed by a split pusher that rotates the handle connection portion to align the second foot with the second receiver opening.

6. The method of claim 1 wherein the handle connection portion is advanced toward the blade unit by a split pusher that rotates the handle connection portion to align the second foot with the second receiver opening, the split pusher comprising a first side which begins in a leading position and a second side which begins in a trailing position to advance the handle connection portion toward the blade unit at an angle.

7. The method of claim 6 wherein the split pusher has two independently advancing sides, where a first side starts at a leading position and a second side advances once the first side reaches the end of its travel.

8. The method of claim 6 wherein the split pusher has a first side and a second side, where the first side is longer than the second side and the split pusher pivots with a non-uniform radius to continue to advance the second side once the first side reaches the end of its travel.

9. The method of claim 8 where the split pusher pivots on a rocker, a cam, or other rotating means.

10. A method of manufacturing a razor cartridge comprising:
a. providing a handle connection portion with a handle connector and a Y-shaped yoke comprising two arms, each arm terminating in an inwardly extending foot, each foot having a length and a terminal end;
b. providing a blade unit with opposite outwardly facing receiver openings on a back surface, the opposite openings configured to receive the inwardly extending feet, where there is a separation distance between edges of the opposite receiver openings;
c. angling the yoke as it advances toward the blade unit for engagement, so that a first foot on the first arm is in a leading position relative to the blade unit;
d. inserting the first foot on the first arm of the yoke into a first receiver opening while a second foot on the second arm of the yoke is not yet at the blade unit;
e. deflecting the arms of the yoke away from each other, to increase the width between the terminal ends of the feet by a value corresponding to the length of the second foot, so the second foot can move past the opening edge of the second retainer opening and into alignment with the second receiver opening;
f. rotating the handle connection portion so that the second foot aligns with the second receiver opening on the blade unit;
g. releasing the force deflecting the arms of the yoke so that the second foot enters and rests in the second receiver opening of the blade unit.

11. The method of claim 10 wherein the angle of the yoke as the first foot is at the first receiver opening is from about 15 degrees to about 45 degrees.

12. The method of claim 10 wherein the angle of the yoke as the first foot is at the first receiver opening is about 30 degrees.

13. A razor cartridge comprising a blade unit pivotally mounted on a handle connection portion, the blade unit comprising shaving blades on a front surface and opposed receiver openings on a back surface for receiving opposed feet on the handle connection portion, the handle connection portion comprising a handle connector configured to be releasably attached to a handle and a yoke comprising a first foot on a first arm and a second foot on a second arm extending outwardly in opposite directions from terminal ends of the first and second arms, wherein each of the first and second foot extend at least 1.28 mm into the receiver openings and a gap between outer arm surfaces below the feet and the inner opposed surfaces of the opposed receiver openings is not more than 0.77 mm when the yoke is pushed to one side of the blade unit, so that one arm is pushed against the respective receiver opening.

14. The razor cartridge of claim 13 wherein the gap between outer arm surfaces below the feet and the inner opposed surfaces of the opposed receiver openings when the blade unit is pushed to one side is from about 0.50 mm to about 0.55 mm.

15. The razor cartridge of claim 13 comprising a distance from a side of the first arm just below the first foot when the first foot is fully inserted into the first receiver opening to the terminal end of the second foot when the yoke arms are deflected to align the second foot with the second receiver opening is from about 26.88 mm to about 27.52 mm.

16. The razor cartridge of claim 13 comprising a distance from a side of the first arm just below the first foot when the first foot is fully inserted into the first receiver opening to the terminal end of the second foot when the yoke arms are deflected to align the second foot with the second receiver opening is about 27.20 mm.
